(19) United States
(12) Patent Application Publication
(10) Pub. No.: US 2015/0026266 A1
(43) Pub. Date: Jan. 22, 2015

(54) SHARE TO STREAM

(71) Applicant: Yahoo! Inc., Sunnyvale, CA (US)

(72) Inventor: Michael Metcalf, San Francisco, CA (US)

(21) Appl. No.: 13/944,519

(22) Filed: Jul. 17, 2013

(51) Int. Cl. H04L 12/58; H04L 29/08

(52) U.S. Cl. CPC H04L 51/18; H04L 67/306
USPC 709/206

(57) ABSTRACT

In one embodiment, a message transmitted from a first individual to a second individual via a communication platform may be identified, where the message includes a media item, a hypertext link providing access to the media item, or a Uniform Resource Locator (URL) providing access to the media item. The media item, hypertext link, or URL may be obtained from the message. The media item, hypertext link, or URL may be inserted into a stream associated with the second individual. The stream may be transmitted to the second individual via a media platform.

### BACKGROUND

The disclosed embodiments relate generally to methods and apparatus for integrating media shared via a communication platform into streams transmitted via a media platform.

Individuals may send private messages to other individuals via the Internet using a number of messaging applications. For example, instant messaging (IM) is a type of online chat that offers real-time text transmission over the Internet. As another example, electronic mail is a method of exchanging digital messages from an author to one or more recipients across the Internet.

In addition, individuals may access information that is published via the Internet. This information is generally publicly available, and may be accessed via any number of web sites.

### SUMMARY

The disclosed embodiments support the insertion of material from a message sent to an individual into a stream transmitted to the individual. The material may include a media item, a hypertext link to a media item, or a Uniform Resource Locator (URL) to a media item.

In one embodiment, a message transmitted from a first individual to a second individual via a communication platform may be identified, where the message includes a media item, a hypertext link providing access to the media item, or a URL providing access to the media item. The media item, hypertext link, or URL may be obtained from the message. The media item, hypertext link, or URL may be inserted into a stream associated with the second individual. The stream may be transmitted to the second individual via a media platform.

In another embodiment, a system includes a communication platform and a media platform. The communication platform may be configured to enable messages to be generated and transmitted via the communication platform. The media platform may be configured to: receive or intercept at least a portion of the messages transmitted via the communication platform, identify one of the messages transmitted via the communication platform, the message being transmitted from a first individual to a second individual and including a media item, a hypertext link providing access to the media item, or a URL providing access to the media item, obtain the media item, hypertext link, or URL from the message, insert the media item, hypertext link, or URL into a stream associated with the second individual, and transmit the stream to the second individual via the media platform.

Various embodiments may be implemented via a device comprising a processor, memory, and a display. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is a process flow diagram illustrating an example method of processing a message in accordance with various embodiments.

FIG. 3 is a diagram illustrating an example graphical user interface presenting a web page including a stream transmitted via a media platform in accordance with various embodiments.

FIG. 4A is a diagram illustrating an example message that may be received via a communication platform in accordance with various embodiments.

FIG. 4B is a diagram illustrating an example graphical user interface presenting a web page including the stream of FIG. 3 after the message shown in FIG. 4A has been transmitted via the communication platform.

FIG. 5 is a schematic diagram illustrating an example embodiment of a network in which various embodiments may be implemented.

FIG. 6 is a schematic diagram illustrating an example client device in which various embodiments may be implemented.

FIG. 7 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Users may receive and send messages via the Internet using a number of applications. Sometimes, these messages may include or reference digital media items. For example, a body of a message or attachment to a message may include one or more digital media items. As another example, a body of a message or attachment to a message may include a Uniform Resource Locator (URL) or hypertext link via which one or more digital media items may be accessed. Such digital media items may include, but are not limited to, news articles, magazine articles, books, audio, video, photographs, and/or other images.

In addition, users have access to a number of information resources via the Internet. As a result, users may access media items that are published via the Internet using a number of web sites.

In order to access both media items published via the Internet and media items that are sent via private messages, this involves switching contexts. Unfortunately, this context switching can occur numerous times per day, which can be time consuming and tedious.

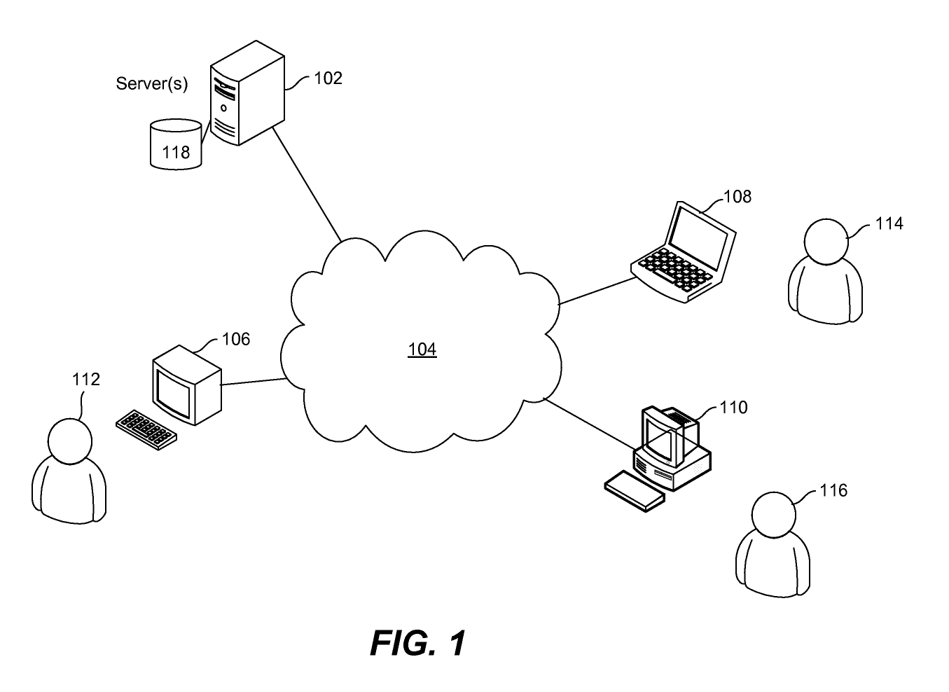

In accordance with various embodiments, media items, hypertext links, or Uniform Resource Locators (URLs) transmitted to an individual via a communication platform may be integrated into a stream provided to the individual via a media platform. The communication platform and media platform may be supported via a single web site. An example of a system supporting both a communication platform and media platform will be described in further detail below with reference to FIG. 1.

### Example System

FIG. 1 is a diagram illustrating an example system in which various embodiments may be implemented. As shown in FIG. 1, the system may include one or more servers 102. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may create, activate, update, delete, deactivate, or otherwise change the status or state of user accounts. In addition, users of the web site may access user accounts or public user profiles, interact with other members of the web site, transmit messages, upload files (e.g., photographs, videos), purchase goods or services, access information such as media items posted on the web site, etc.

In accordance with various embodiments, at least one of the servers 102 may provide a communication platform that supports the transmission of messages via one or more applications. The communication platform may support one-to-one communications, as well as one-to-many communications. For example, such applications may include an electronic messaging application, an instant messaging application such as Yahoo! Messenger, and/or a microblogging application. Example microblogging applications include Twitter and Facebook. The communication platform may enable user accounts and associated contacts established via the various applications to be linked, either automatically or in response to initiation by a user.

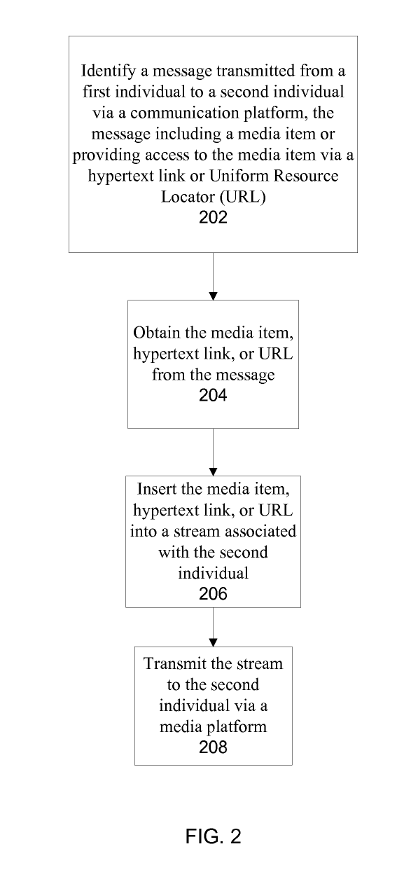

Similarly, at least one of the servers 102 may provide a media platform that supports the generation and transmission of streams to various individuals via the web site. More particularly, each stream may include or otherwise provide access to a plurality of media items that have been identified via the Internet and are accessible via the Internet. In addition, a stream may include one or more advertisements or other information. In some embodiments, the plurality of media items (and any advertisements) may “personalized” such that they are selected and/or prioritized for transmission to a particular individual accessing the stream. While the media platform may support one-to-many communications via different streams, each personalized stream may be directed to a single individual. Of course, each of the plurality of media items transmitted in one stream may also be transmitted in other, additional streams to different individuals. Various systems and processes for integrating media items from communications transmitted to an individual via the communication platform into a stream provided to the individual via the media platform will be described in further detail below with reference to FIGS. 2 through 4B.

The server(s) 102 may obtain, collect, or otherwise receive data (e.g., account data and/or user profile), enabling a stream to be personalized for a particular user. The server(s) 102 may support requests (e.g., search requests, selection of a particular media item) that enable users to access media items provided via a stream. In addition, the server(s) 102 may support the generating, sending and receiving of messages via one or more applications. Message(s) may be sent via the Internet 104 from a single individual to one or more other individuals 112, 114, 116, who may receive the message(s) via corresponding client devices 106, 108, 110. Upon receiving or intercepting a message to a user, the server(s) 102 may insert selected messages or portions thereof into a stream that is provided to the user. For example, the server(s) may insert a media item, hypertext link, or URL into the stream

The server(s) 102 may have access to one or more data stores 118, which may include one or more memories. More particularly, the data stores 118 may include account information (e.g., data) for a plurality of user accounts. Therefore, account information pertaining to user accounts may be retained in one or more memories that are coupled to the server 102.

Account information may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)).

The user information retained in the user logs 118 may include personal information such as demographic information (e.g., age and/or gender) and/or geographic information (e.g., residence address, work address, and/or zip code). In addition, each time a user performs online activities such as clicking on an advertisement or media item, purchasing goods or services, sending messages, retrieving messages, accessing a media item via a message, posting information or content (e.g., on a web site or within the user's public profile), or annotating content, information regarding such activity or activities may be retained as user data in the user logs 118. For instance, the user data that is retained in the user logs 118 may indicate the identity of web sites visited, identity of ads or media items that have been selected (e.g., clicked on) and/or a timestamp. Moreover, where the online publisher supports a search engine (e.g., via the server 102 or a separate search server), information associated with a search query, such as search term(s) of the search query, information indicating characteristics of search results that have been selected (e.g., clicked on) by the user, and/or associated timestamp may also be retained in the user logs 118. A user may be identified in the user logs 118 by a user ID (e.g., user account ID), information in a user cookie, etc.

The data stores 118 may also store content or references to content, which may include media items, hypertext links via which media items may be accessed, and/or URLs via which media items may be accessed. In some embodiments, the content may also include advertisements. The content may be indexed for efficient retrieval.

In one embodiment, as an individual interacts with a software application, e.g., an instant messenger or electronic mail application, descriptive content such as, for example, an email address, instant messenger identifier, phone number, postal address, message content, date, time, etc., may be identified and stored in the data stores 118 (e.g., in association with content such as media items). Descriptive content may be stored along with contextual content. For example, how content such as a phone number (or media item) came to be identified (e.g., it was contained in a communication received from another via an instant messenger application) may be stored in the data stores 118 as contextual content associated with the content. Contextual content, therefore, may identify circumstances surrounding receipt of content (e.g., date or time a media item or phone number was received) and may be associated with descriptive content in the data stores 118. Contextual content, may, for example, be used to subsequently search for associated descriptive content. For example, a search for phone numbers received from specific individuals, received via an instant messenger application or at a given date or time, may be initiated.

Content (e.g., media items or identification thereof) within a repository of media or multimedia within the data stores 118 may be annotated. Examples of content may include text, images, audio, video, or the like, which may be processed or stored in memory. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from (or transmitted to) an individual, such as a user, and stored in association with the individual or the content item. Annotations may include various fields of descriptive content, such as a rating of a document, circumstances or context pertaining to the receipt of a document, a list of keywords identifying topics of a document, etc.

A profile builder may initiate generation of a profile, such as for users of an application, including a search engine or messaging application, for example. A profile builder may initiate generation of a user profile for use, for example, by a user, as well as by an entity that may have provided the application. For example, a profile builder may enhance relevance determinations and thereby assist in indexing, searching or ranking search results. Therefore, a search engine provider may employ a profile builder.

A variety of mechanisms may be implemented to generate and/or update a profile including, but not limited to, collecting or mining navigation history, stored documents, tags, or annotations, to provide a few examples. A profile builder may store a generated profile. Through the use of user profiles of a search engine, for example, a search engine provider may retrieve annotations, tags, stored pages, navigation history, or the like, which may be useful for making relevance determinations of search results, such as with respect to a particular user, which may be provided in a stream via a media platform.

FIG. 2 is a process flow diagram illustrating an example method of processing a message in accordance with various embodiments. As shown in FIG. 2, a message transmitted from a first individual to a second individual via a communication platform may be identified at 202, where the message includes or otherwise provides access to a media item. For example, the message may provide access to the media item via a hypertext link or a Uniform Resource Locator (URL). The communication platform may identify the message including or providing access to a media item upon transmission, receipt, or interception of the message via the communication platform. If a message does not include or otherwise provide access to a media item, the communication platform may not identify the message as one to be processed.

In addition, various security checks may be performed prior to processing the message. More particularly, the identity of the first individual may be verified as an individual that the second individual knows or has communicated with previously. For example, an identifier of the first individual may be compared to contact list(s) of the second individual. Such contact list(s) may be any contact lists including, but not limited to, contact lists maintained via the web site or the communication platform. Moreover, such contact list(s) may have been generated or updated via the second individual, or may have been generated or updated in accordance with various embodiments. In some embodiments, where the first individual is unrecognized in any of the contact lists of the second individual, the second individual may be asked to confirm (e.g., via an electronic mail message) whether the first individual should be added as one of their contacts. The first individual may be added to one of the contact lists based, at least in part, upon a response of the second individual or lack thereof. For example, the second individual may provide a response via a separate electronic mail message or by clicking a link provided in the electronic mail message requesting confirmation. In addition, a spam filter may be applied to verify that the message is not spam. This may include, for example, checking a source of the message, the media item, hypertext link, URL, and/or other content of the message.

The message may be transmitted via one or more applications, which may be made available or supported by the communication platform. For example, the message may be generated via a microblogging application, an instant messaging application such as Yahoo! Messenger, or an electronic mail application. While the message may include an electronic mail message, an instant message, or a microblogging message, these examples are merely illustrative. Accordingly, other types of messages may be processed in accordance with the disclosed embodiments.

In some embodiments, the message may be a one-to-one communication transmitted by the first individual to only the second individual. In other embodiments, the message may be transmitted by the first individual to two or more individuals including the second individual.

The media item, hypertext link, or URL may be obtained from the message at 204. For example, the media item, hypertext link, or URL may be obtained from a body of the message or attachment to the message. The media item may include text, video, audio, a photograph, and/or other image. For example, the media item may include a document such as a news or magazine article. As another example, the media item may include a song.

The media item, hypertext link, or URL may be inserted into a stream associated with the second individual at 206. More particularly, where a hypertext link or URL has been obtained from the message, the hypertext link, URL, or the associated media item may be inserted into the stream. Alternatively, the media item obtained from the message may be inserted into the media stream. The insertion may be performed by a media platform, which may also be responsible for generating and transmitting the stream, as will be described in further detail below.

Where the media item has been transmitted or referenced in a message specifically transmitted to the second individual from an individual that the second individual knows or has communicated with previously, it may be inferred that the media item is of particular interest to the second individual. As a result, it may be assumed that the media item is of greater interest to the second individual than other media items in the stream. Accordingly, the media item, hypertext link providing access to the media item, or URL providing access to the media item may be inserted at the top or beginning of the stream.

In some embodiments, the inserting may be performed based, at least in part, upon one or more characteristics of the media item, one or more characteristics of the message, and/or a user profile associated with the second individual. More particularly, the prioritization or placement of the media item, hypertext link, or URL within the stream may be ascertained based, at least in part, upon one or more characteristics of the media item, one or more characteristics of the message, and/or a user profile of the second individual. For example, the prioritization or placement may be determined based, at least in part, upon a type of relationship between the first individual and the second individual. Thus, where the user profile of the second individual indicates a particularly close relationship with the first individual who transmitted the message, the media item, hypertext link, or URL may be prioritized or placed at the top or beginning of the stream. Alternatively, where the user profile indicates that the first individual is merely an acquaintance of the second individual, the media item, hypertext link, or URL may be inserted in the middle or bottom of the stream. In this manner, the prioritization or placement may be determined based, at least in part, upon a likelihood of interest of the second individual in the media item.

In addition, information pertaining to the message may be inserted into the stream at or near a location at which the media item, hypertext link, or URL has been inserted. More particularly, the information may indicate an identity of the first individual, an application via which the message was transmitted, textual comments provided by the first individual in a body of the message (or portion thereof), a date and/or time at which the message was transmitted by the first individual, and/or other material that has been obtained or detected from the message. For example, the identity of the first individual may be designated by a name of the individual and/or an image identifying the individual.

It may be particularly useful to insert an indication of the identity of the first individual into the stream, thereby enabling the second individual to ascertain his or her level of interest in the media item. However, the amount of the information that is inserted into the stream may be determined based, at least in part, upon one or more characteristics of the media item, one or more characteristics of the message, and/or the profile of the second individual. For example, where the first individual that transmitted the message has a particularly close relationship with the second individual, the textual comments or portion thereof may be inserted into the stream.

The stream may be transmitted to the second individual via a media platform at 208. The stream, which may be referred to as a media stream, may further include or otherwise provide access to a plurality of media items. In addition, the stream may include one or more advertisements and/or other information.

As shown in FIG. 2, the insertion performed at 206 may be initiated and/or completed prior to transmitting the stream at 208. However, it is important to note that the operations 202-208 need not be performed in the order in which they are presented in FIG. 2. For example, the insertion performed at 206 may be initiated after the transmitting has been initiated at 208. Thus, the insertion at 206 may be performed during the generation and/or transmission of the stream. Accordingly, the insertion may be performed in parallel with the generation and/or transmission of the stream.

The stream may be generated or modified such that each of the plurality of media items are included or referenced (e.g., via URL or hypertext link) as they are identified as relevant to the second individual. As a result, the stream may be generated or modified in real-time.

The stream may be transmitted via a web site associated with the media platform. More particularly, the stream may be transmitted via a web page when the web site is accessed by the second individual. For example, the stream may be transmitted when the second individual accesses a particular web page (e.g., home page) of the web site that is displayed via a monitor or screen. The insertion of the media item, hypertext link, URL, and/or information associated therewith into the stream may be accomplished by modifying the web page or during the generation of the web page via which the stream is displayed.

The operations 202-206 may be performed in real-time after the message is transmitted. As a result, the stream presented via the web page being viewed by the user at 208 may be updated in real-time as the user views or scrolls through the stream or web page.

The stream may further include or otherwise provides access to a plurality of media items that have been selected for the second individual based, at least in part, upon a user profile associated with the second individual. For example, the stream may provide access to one or more of the plurality of media items via corresponding hypertext links or URLs. In addition, each of the plurality of media items may be provided to additional individuals other than the second individual via corresponding streams that are personalized and transmitted to those individuals

Assuming that the media item, hypertext link providing access to the media item, or URL providing access to the media item has been transmitted in a message from an individual that the second individual knows or has communicated with previously, or has a particularly close relationship with, it may be assumed that the media item is of interest to the second individual. Thus, one or more characteristics of the media item may be ascertained, and a user profile associated with the second individual may be updated based, at least in part, upon the one or more characteristics of the media item. In addition, a profile associated with the first individual may also be updated based, at least in part, upon the characteristics of the media item.

Characteristics of the media item may include one or more types of the media item. For example, the type(s) of the media item may include text, video, audio, photograph, or other image. The characteristics of the media item may also include a primary subject of the media item. In addition, the characteristics of the media item may indicate a source of the media item. For example, the source of the media item may include the first individual and/or a web site identified in a hypertext link or URL.

The user profile of the second individual may be updated to indicate whether the media item is of interest to the second individual. More particularly, it may be determined whether the second individual accesses the media item, hypertext link, or URL in the stream. For example, a number of clicks or views of the media item may be ascertained. The user profile associated with the second individual may be updated based, at least in part, upon whether the second individual accesses the media item, hypertext link, or URL. For example, the user profile may indicate whether the second individual clicked on or viewed the media item and, if so, the number of clicks or views within a particular time period.

Based upon the information recorded in the user profile of the second individual, a machine learning algorithm may attempt to learn how to better identify characteristics of media items that may be of interest to the second individual in the future based, at least in part, upon the characteristics of the media item. For example, the machine learning algorithm may ascertain an identity of those individuals who are most likely to be a source of media items that are of interest to the second individual. For example, factors such as frequency of communications between a given individual and the second individual and/or frequency of responses by the second individual to communications from a given individual may be implemented to rank individuals (e.g., contacts) or assign weights to the individuals, where the weights indicate a likelihood that the corresponding individual will be a source of media items that will be of interest to the second individual. These weights or rankings may then be applied to select and/or prioritize the plurality of media items for transmission in the stream. In addition, these weights or rankings may be applied to assist in identifying an appropriate placement of a media item within a stream prior to its insertion. For example, the weights or rankings may enable a priority of the media item with respect to the plurality of media items in the stream to be ascertained.

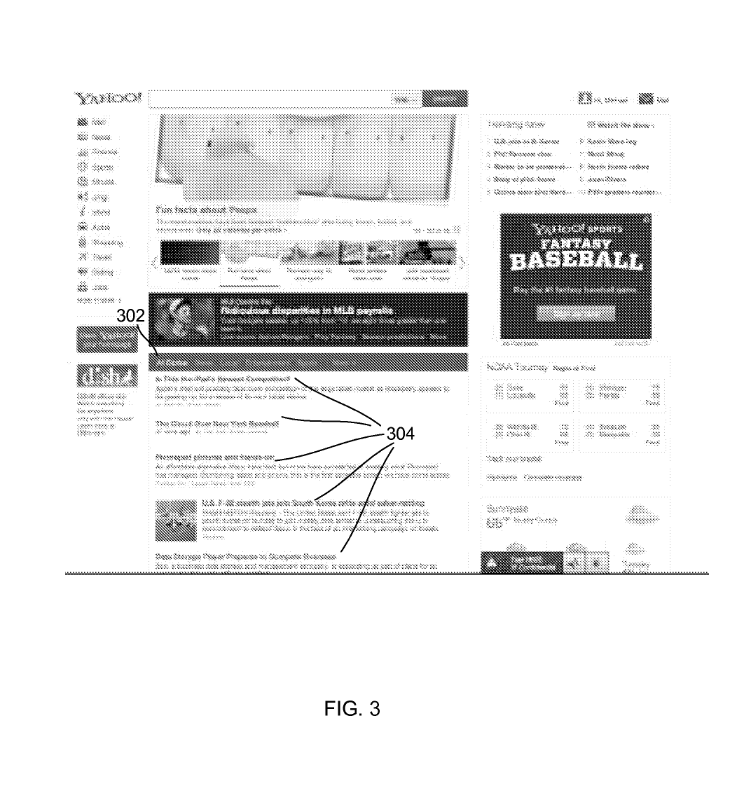

FIG. 3 is a diagram illustrating an example graphical user interface presenting a web page including a stream transmitted via a media platform in accordance with various embodiments. As shown in this example, a stream 302 may be displayed in a segment of the web page, as shown under heading “All Stories.” This segment of the web page may be referred to as a “Today Module.” In this example, the stream 302 provides access to a plurality of media items via corresponding hypertext links 304. More particularly, each of the hypertext links 304 provides access to a corresponding one of the plurality of media items, which have been selected for presentation to the second individual

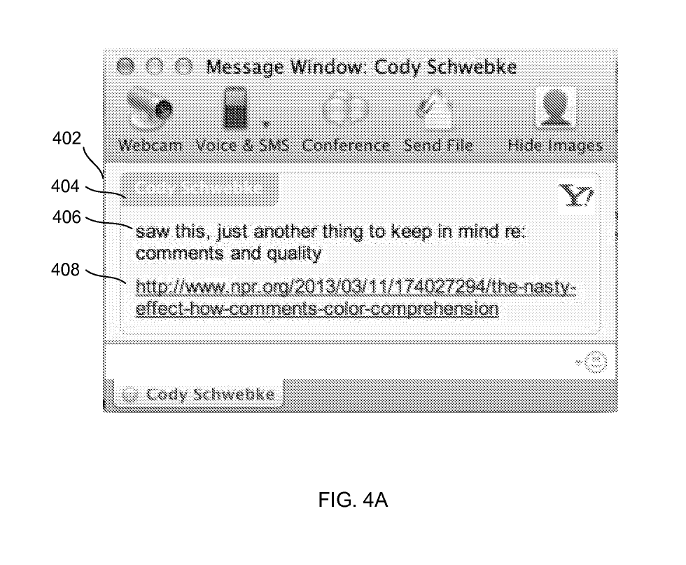

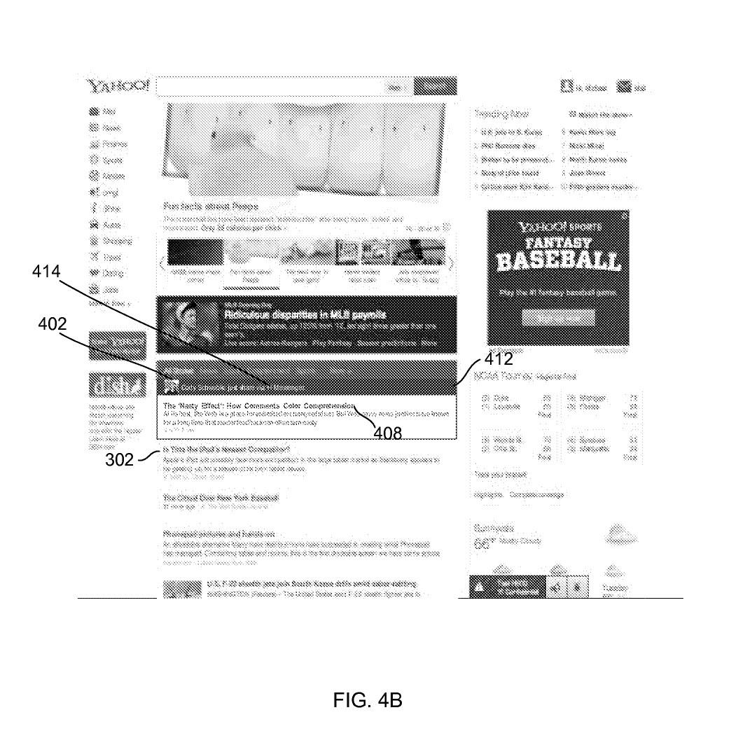

FIG. 4A is a diagram illustrating an example message that may be received via a communication platform in accordance with various embodiments. As shown in this example, the graphical user interface may indicate an identity of the first individual 402 that sent a message 404. In addition, a body of the message may include textual comments 406 provided by the first individual. In this example, the body of the message also includes a hypertext link 408 providing access to a media item, which is an article entitled, “How Comments Color Comprehension.”

In accordance with various embodiments, the message that has been transmitted may be processed automatically, as set forth above. In other embodiments, such processing may be performed in response to initiation by the first individual. For example, the first individual may click a “Share to Stream” button (not shown), which may be presented when the first individual generates the message or upon sending the message. The message that is sent may also include an indication that a media item included or otherwise referenced in the message is also available in the stream provided to the second individual via the web site. For example, the message may indicate that the user may now access media items, which may have been personally sent to them through a number of applications, via the web site.

FIG. 4B is a diagram illustrating an example graphical user interface presenting a web page including the stream of FIG. 3 after the message shown in FIG. 4A has been transmitted via the communication platform. As shown in this example, the stream 302 shown in FIG. 3 is updated to include the hypertext link 408 providing access to the media item, the article entitled, “How Comments Color Comprehension.” In addition, as shown in FIG. 4B, information 412 indicating the identity of the first individual 402 and an application 414 via which the message was transmitted are presented in close proximity to the hypertext link 408.

It may be assumed that a media item included or otherwise referenced in a message transmitted to the second individual may be of particular interest to the second individual. As a result, a media item, hypertext link, or URL obtained from the message may be prioritized by inserting the media item, hypertext link, or URL at the beginning or top of the stream 302, as shown in FIG. 4B. Such prioritization may also be indicated via other mechanisms, such as the size and/or color of the font of the media item, hypertext link, or URL that is inserted. Although the comments 406 provided in the message 404 of FIG. 4A are not provided in the stream 302 in this example, the comments 406 or portion thereof may be inserted into the stream in some instances. For example, where the first individual 402 that transmitted the message 404 has a particularly close relationship to the second individual, the comments 406 or portion thereof may also be inserted into the media stream 302.

The disclosed embodiments enable information from personal communications to be inserted into personalized streams presenting media items that are identified and available via the Internet. This information may include media items or references to the media items, where the references to the media items include hypertext links and/or URLs. As a result, personal communications such as one-to-one communications may be leveraged to integrate media items identified therein into streams transmitted via a media platform.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

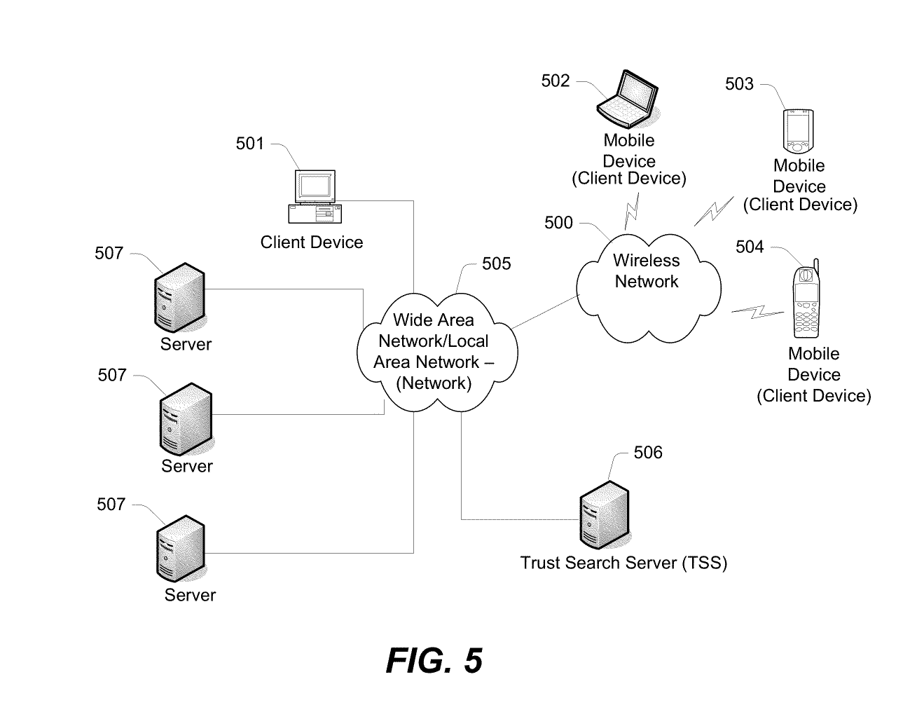

The disclosed embodiments may be implemented in any of a wide variety of computing contexts. FIG. 5 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 505 and wireless network 500, a variety of devices, such as client devices 501-504, and a variety of servers such as content server(s) 507 and search server 506. The servers may also include an ad server (not shown). As shown in this example, the client devices 501-504 may include one or more mobile devices 502, 503, 504. Client device(s) 501-504 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

A media platform and/or communication platform may be implemented in some centralized manner. This is represented in FIG. 5 by server(s) 507, which may correspond to multiple distributed devices and data store(s). The server(s) 507 and/or corresponding data store(s) may store user account data and other user information.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Crawler

A crawler may be operable to communicate with a variety of content servers, typically via a network. In some embodiments, a crawler starts with a list of URLs to visit. The list may be called a seed list. As the crawler visits the URLs in the seed list, it identifies all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

Indexing

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

Client Device

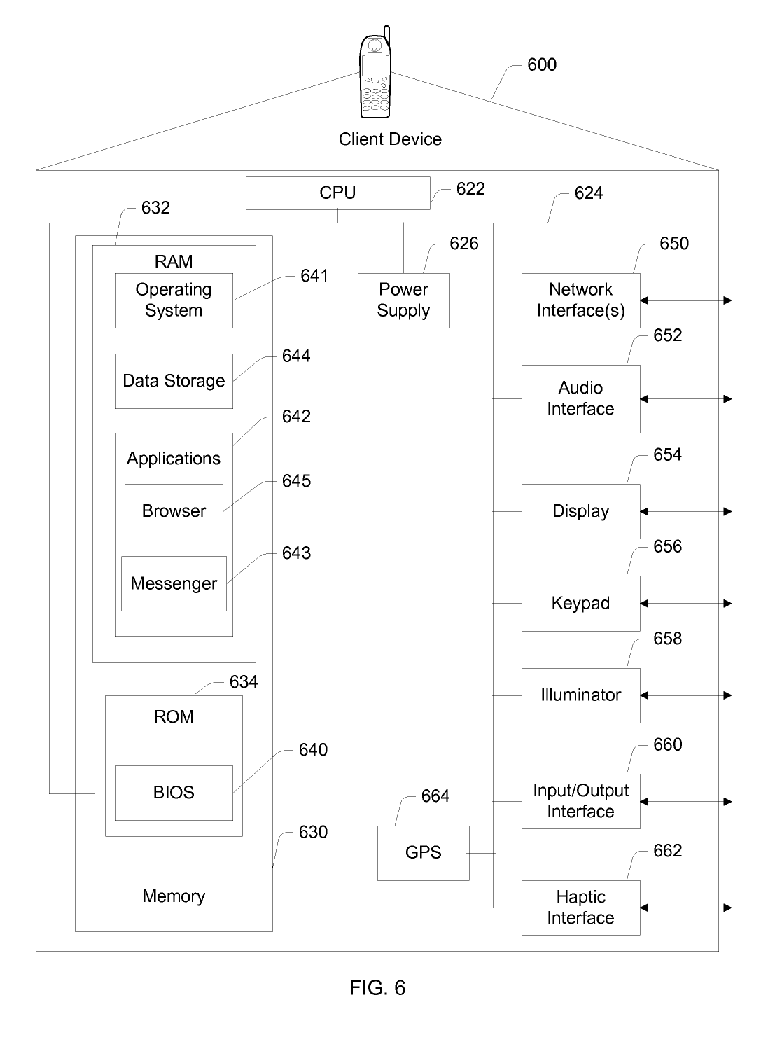

A user may attempt to access his or her home page of a web site to view a stream of media items via a client device. FIG. 6 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 600 may include one or more central processing units (CPUs) 622, which may be coupled via connection 624 to a power supply 626 and a memory 630. The memory 630 may include random access memory (RAM) 632 and read only memory (ROM) 634. The ROM 634 may include a basic input/output system (BIOS) 640.

The RAM 632 may include an operating system 641. More particularly, a client device may include or may execute a variety of operating systems, including a personal computer operating system, such as a Windows, iOS or Linux, or a mobile operating system, such as iOS, Android, or Windows Mobile, or the like. The client device 600 may also include or may execute a variety of possible applications 642 (shown in RAM 632), such as a client software application such as messenger 643, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 600 may also include or execute an application to communicate content, such as, for example, textual content, multimedia content, or the like, which may be stored in data storage 644. A client device may also include or execute an application such as a browser 645 to perform a variety of possible tasks, such as browsing, searching, playing various forms of content, including locally stored or streamed video, or games (such as fantasy sports leagues).

The client device 600 may send or receive signals via one or more interface(s). As shown in this example, the client device 600 may include one or more network interfaces 650. The client device 600 may include an audio interface 652. In addition, the client device 600 may include a display 654 and an illuminator 658. The client device 600 may further include an Input/Output interface 660, as well as a Haptic Interface 662 supporting tactile feedback technology.

The client device 600 may vary in terms of capabilities or features. Claimed subject matter is intended to cover a wide range of potential variations. For example, a cell phone may include a keypad such 656 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 664 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

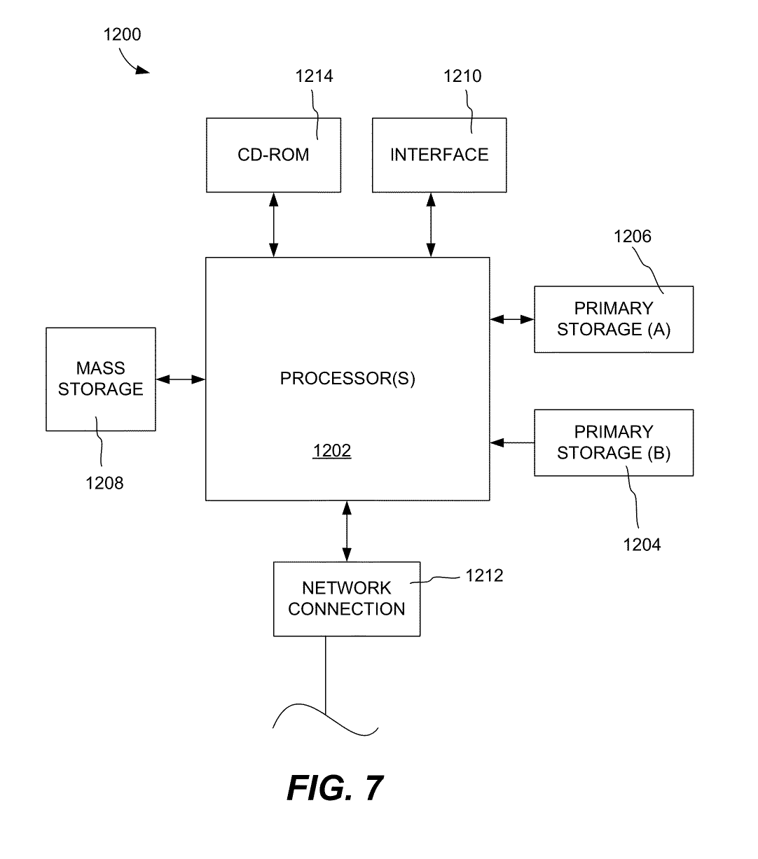

FIG. 7 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
identifying a message transmitted from a first individual to a second individual via a communication platform, the message including a media item, a hypertext link providing access to the media item, or a Uniform Resource Locator (URL) providing access to the media item;
obtaining the media item, hypertext link, or URL from the message;
inserting the media item, hypertext link, or URL into a stream associated with the second individual; and
transmitting the stream to the second individual via a media platform.

2. The method as recited in claim 1, wherein the inserting comprises generating or modifying a web page, and wherein transmitting the stream comprises transmitting the web page when a web site associated with the media platform is accessed by the second individual.

3. The method as recited in claim 1, wherein the stream includes or otherwise provides access to a plurality of media items that have been selected for the second individual based, at least in part, upon a user profile associated with the second individual.

4. The method as recited in claim 1, further comprising:
ascertaining one or more characteristics of the media item; and
updating a user profile associated with the second individual based, at least in part, upon the one or more characteristics of the media item.

5. The method as recited in claim 1, further comprising:
determining whether the second individual accesses the media item, hypertext link, or URL in the stream; and
updating a user profile associated with the second individual based, at least in part, upon whether the second individual accesses the media item, hypertext link, or URL.

6. The method as recited in claim 1, inserting is performed based, at least in part, according to one or more characteristics of the media item, one or more characteristics of the message, and/or a user profile associated with the second individual.

7. The method as recited in claim 1, wherein the identifying, obtaining, and inserting steps are performed in real-time after the message is transmitted.

8. The method as recited in claim 1, wherein the message comprises an electronic mail message, an instant message, or a microblogging message.

9. The method as recited in claim 1, wherein the message is a one-to-one communication.

10. The method as recited in claim 1, wherein the inserting is performed during the transmitting the stream.

11. The method as recited in claim 1, wherein the inserting is initiated after the transmitting has been initiated.

12. The method as recited in claim 1, further comprising:
inserting information pertaining to the message at or near a location in the stream at which the media item, hypertext link, or URL has been inserted.

13. A system, comprising:
a communication platform that is configured to enable messages to be generated and transmitted via the communication platform;
a media platform that is configured to:
receive or intercept at least a portion of the messages transmitted via the communication platform;
identify one of the messages transmitted via the communication platform, the message being transmitted from a first individual to a second individual and including a media item or a reference to the media item, the reference including a hypertext link or a Uniform Resource Locator (URL);
obtain the media item, hypertext link, or URL from the message;
insert the media item, hypertext link, or URL into a stream associated with the second individual; and
transmit the stream to the second individual via the media platform.

14. The system as recited in claim 13, wherein the communication platform comprises an instant messaging platform, an electronic mail platform, or a microblogging platform.

15. The system as recited in claim 13, wherein the communication platform supports one-to-one communication between individuals.

16. The system as recited in claim 13, wherein the media platform is further configured to generate the stream, wherein the stream includes or otherwise provides access to a plurality of media items that are each provided to additional individuals other than the second individual via corresponding streams.

17. A non-transitory computer-readable medium storing thereon computer-readable instructions for performing a method, comprising:
identifying a message transmitted from a first individual to a second individual via a communication platform, the message including a media item, a hypertext link providing access to the media item, or a Uniform Resource Locator (URL) providing access to the media item;
obtaining the media item, hypertext link, or URL from the message;
inserting the media item, hypertext link, or URL into a stream associated with the second individual; and
transmitting the stream to the second individual via a media platform.

18. The non-transitory computer-readable medium as recited in claim 17, wherein the identifying, obtaining, and inserting steps are performed in real-time after the message is transmitted.

19. The non-transitory computer-readable medium as recited in claim 17, wherein the inserting is performed during the transmitting the stream.

20. The non-transitory computer-readable medium as recited in claim 17, wherein the inserting is initiated after the transmitting has been initiated.
